(19) United States
(12) Patent Application Publication
(10) Pub. No.: US 2025/0309792 A1
(43) Pub. Date: Oct. 2, 2025

(54) VIBRATION ACTUATOR, OPTICAL DEVICE, AND ELECTRONIC DEVICE

(71) Applicant: CANON KABUSHIKI KAISHA, Tokyo (JP)

(72) Inventors: YASUYUKI ARAKI, Tokyo (JP); SATOSHI TSUCHIYA, Saitama (JP)

(21) Appl. No.: 19/088,733

(22) Filed: Mar. 24, 2025

(30) Foreign Application Priority Data
Mar. 26, 2024 (JP) 2024-050590

(51) Int. Cl. H02N 2/10; B25J 9/12; G02B 7/04; H02N 2/00

(52) U.S. Cl. CPC H02N 2/103; B25J 9/126; G02B 7/04; H02N 2/22

(57) ABSTRACT

A vibration actuator includes a vibrating body including an electrical energy-mechanical energy conversion element and an elastic body and a contact body in contact with a surface of the elastic body via a contact surface, in which vibration of the vibrating body causes relative movement of the vibrating body with respect to the contact body. The contact body includes a hard material portion and a resin portion, the hard material portion and the resin portion are exposed to the contact surface, and the hard material portion includes a plurality of thin plate portions, and the resin portion is present at least in a gap between the thin plate portions.

### BACKGROUND

### Field

The present disclosure relates to a vibration actuator, an optical device, and an electronic device.

### Description of the Related Art

There is a known vibration actuator that brings a vibrating body including an electrical energy-mechanical energy conversion element into pressurized contact with a contact body, excites certain vibration in the vibrating body, provides a frictional driving force from the vibrating body to the contact body, and accordingly, moves the vibrating body relative to the contact body. Such a vibration actuator has a large holding force because it uses a friction force caused by pressurized contact. Accordingly, even when an external force is applied with no electricity supplied, the position relationship between the vibrating body and the contact body can be maintained.

Japanese Patent Laid-Open No. 2022-30103 discloses a technology that uses, as the contact body, a stainless sintered product impregnated with a resin mixed with hard particles. In addition, Japanese Patent Laid-Open No. 2016-63712 discloses a technology that uses a contact body in which a groove is formed in a metal body and a resin is provided in the groove.

### SUMMARY

The present disclosure provides a vibration actuator with a small variation in performance and a high holding force. The present disclosure also provides an optical device or an electronic device including a vibration actuator with a small variation in performance and a high holding force.

The vibration actuator and the optical device or the electronic device described above are achieved by the present disclosure below. According to some embodiments, a vibration actuator includes: a vibrating body including an electrical energy-mechanical energy conversion element and an elastic body; and a contact body in contact with a surface of the elastic body via a contact surface, vibration of the vibrating body causing relative movement of the vibrating body with respect to the contact body, in which the contact body includes a hard material portion and a resin portion, the hard material portion and the resin portion are exposed to the contact surface, and the hard material portion includes a plurality of thin plate portions, and the resin portion is present at least in a gap between the thin plate portions.

Further features of the present disclosure will become apparent from the following description of exemplary embodiments with reference to the attached drawings.

### BRIEF DESCRIPTION OF THE DRAWINGS

FIGS. 1A and 1B are perspective views illustrating a vibration actuator according to a first embodiment.

FIGS. 2A and 2B are diagrams for describing two bending oscillation modes excited in a vibrating body.

FIGS. 3A and 3B are schematic views of a contact body according to the first embodiment.

FIGS. 4A to 4D are cross-sectional views for describing a method of manufacturing the contact body according to the first embodiment.

FIGS. 5A and 5B are cross-sectional views of a contact body according to a second embodiment.

FIGS. 6A to 6E are cross-sectional views for describing a method of manufacturing a contact body according to a third embodiment.

FIGS. 7A and 7B are schematic views of a contact body according to a fourth embodiment.

FIGS. 8A and 8B are diagrams illustrating the structure of an imaging device according to a fifth embodiment.

FIG. 9 is a perspective view illustrating the schematic structure of a robot according to the fifth embodiment.

### DESCRIPTION OF THE EMBODIMENTS

In a friction material in which a stainless sintered product is impregnated with a resin, the higher the proportion of the resin present in hole portions exposed to a friction surface in contact with a vibrating body, the higher the holding force that can be maintained. One method to increase the proportion of the resin present in the hole portions is to increase the ratio (porosity rate) of the hole portions in the sintered product. However, a stable sintered product having a high void ratio cannot be easily manufactured because collapse is likely to occur during a molding step prior to a sintering step.

In addition, in a structure in which a resin is provided in a groove of a metal body, the proportion of the resin can be increased by increasing the width of the groove, but retention may occur when the proportion of the resin is too large.

The present disclosure will be further described in detail below with reference to embodiments.

The present inventors have studied a method of providing a contact body (friction material) in which the proportion of the resin exposed to the contact surface is appropriately adjusted in a vibration actuator. As a result, they have found that, in the manufacturing method that impregnates hole portions of a metal sintered product with a resin, a variation in the amount of polishing and the like may cause a variation in the proportion of the resin in the friction surface.

The present inventors have further studied, based on the knowledge described above, and considered a structure in which resin portions are provided in gaps between hard material portions including a plurality of thin plate portions and a contact body having a shape in which the hard material portion and the resin portion are exposed to the contact surface is formed. As a result, the present inventors have found that a vibration actuator with a small variation in performance and a high holding force can be obtained regardless of the amount of polishing.

### First Embodiment

Various exemplary embodiments, features, and aspects of the present disclosure will be described in detail below with reference to the drawings. Basic Structure of Vibration Actuator

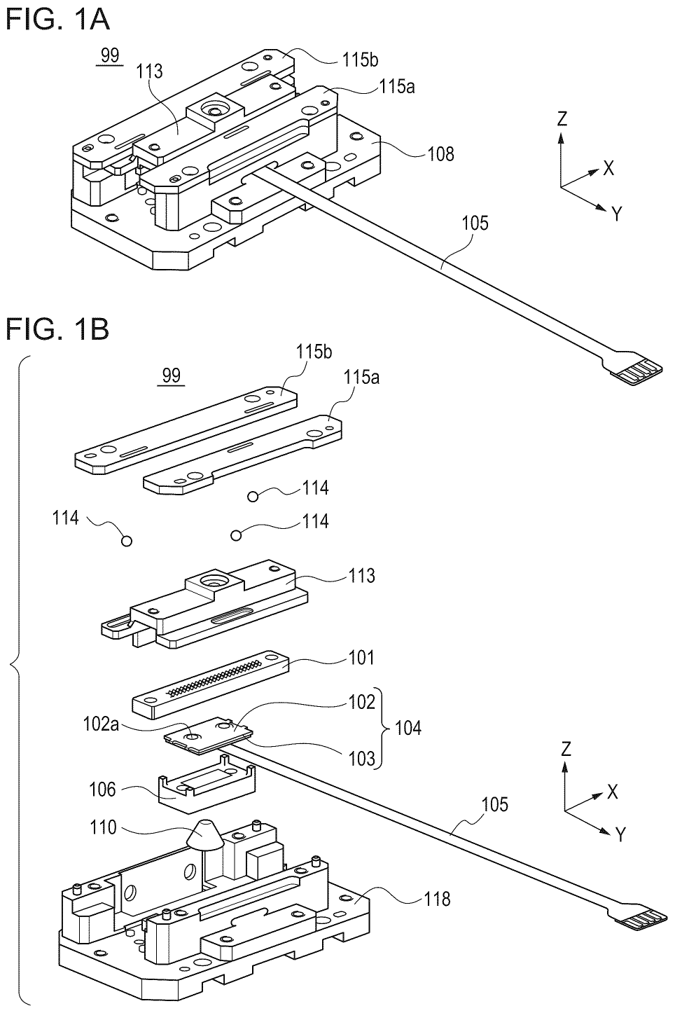

FIG. 1A is a perspective view illustrating the schematic structure of a vibration actuator 99 according to a first embodiment. FIG. 1B is an exploded perspective view in which the vibration actuator 99 in FIG. 1A is disassembled. Here, the direction (movement direction) in which a vibrating body 104 moves relative to a contact body 101 is defined as an X-direction, the pressure direction in pressurized contact between the vibrating body 104 and the contact body 101 is defined as a Z-direction, and the direction orthogonal to the X-direction and the Z-direction is defined as a Y-direction.

As illustrated in FIG. 1B, the vibration actuator includes the vibrating body 104 and the contact body 101 in contact with the vibrating body 104. The vibrating body 104 includes a planar elastic body 102, a piezoelectric element 103, which is an electrical energy-mechanical energy conversion element bonded to one surface of the elastic body 102, and two projecting portions 102a provided on the other surface of the elastic body 102.

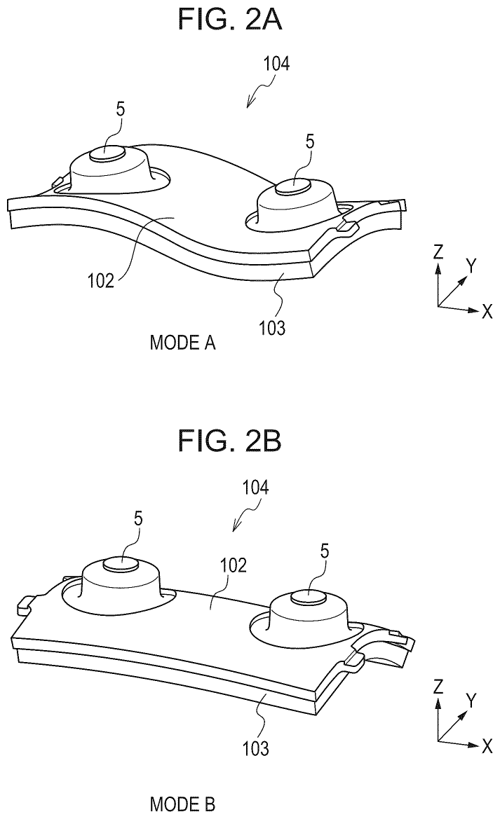

FIG. 2A is a diagram for describing a first vibration mode (referred to below as mode A) of two bending oscillation modes excited in the vibrating body 104. A common electrode (full surface electrode), which is not illustrated, is formed on a surface of the piezoelectric element 103 closer to the elastic body 102, and a gate electrode (not illustrated) divided into two equal portions in the longitudinal direction is formed on a surface opposite to the surface closer to the elastic body 102.

Mode A is secondary bending oscillation of the vibrating body 104 in the longitudinal direction (X-direction) and has three nodal lines that are substantially parallel to the traversal direction (Y-direction (width direction)) of the vibrating body 104. By application of an alternating voltage with a phase shift of 180 degrees at a certain frequency to the gate electrode of the piezoelectric element 103, vibration in mode A can be excited in the vibrating body 104. The projecting portion 5 is disposed near the position of a node in vibration in mode A. The projecting portion 5 performs reciprocating motion in the X-direction when vibration in mode A is excited in the vibrating body 104.

FIG. 2B is a diagram for describing a second vibration mode (referred to below as mode B) of the two bending oscillation modes excited in the vibrating body 104. Mode B is primary bending oscillation of the vibrating body 104 in the traversal direction (Y-direction) and has two nodal lines that are substantially parallel to the longitudinal direction (X-direction). By application of an alternating voltage with the same phase at a certain frequency to the gate electrode of the piezoelectric element 103, vibration in mode B can be excited in the vibrating body 104. The projecting portion 5 is disposed near the position at which an antinode portion is generated in vibration in mode B. The projecting portion 5 performs reciprocating motion in the axial direction (Z-direction) of the projecting portion 5 when vibration in mode B is excited in the vibrating body 104.

The vibrating body 104 is configured such that the nodal lines in mode A are substantially orthogonal to the nodal lines in mode B in an XY plane. In addition, a flexible cable (not illustrated) is bonded to the piezoelectric element 103, and vibration in mode A and vibration in mode B can be excited simultaneously in the vibrating body 104 by AC current being supplied to the piezoelectric element 103 through the flexible cable. Accordingly, ellipsoidal movement can be generated in a ZX plane at the end of the projecting portion 5 by vibration in mode A and vibration in mode B being excited with a certain phase difference.

In the vibration actuator, the vibrating body 104 is in contact with the contact body 101. Accordingly, by vibration in mode A and vibration in mode B being excited at the same time in the vibrating body 104, substantially ellipsoidal movement generated at the ends of the two projections moves the vibrating body 104 relative to the contact body 101.

In the following description, the direction in which the vibrating body 104 moves relative to the contact body 101 is assumed to be a driving direction.

As illustrated in FIG. 1B, a holding member 106, which is a contact member with which the vibrating body 104 makes contact and pressurizes and supports the vibrating body 104, is provided below the vibrating body 104. A component that brings the vibrating body 104 into pressure-contact with the contact body 101 is a pressing spring 110. The holding member 106 receives a pressing force in the Z-direction from the pressing spring 110, and a reaction force thereof is received by a base stage 118, which is a pressure receiving member. A conical coil spring is used as the pressing spring 110 in the present embodiment, but a tension spring or the like may also be used. It should be noted that the coil shape is simplified in the drawing. The pressing spring 110 applies a certain pressing force, that is, a pressing force of several hundreds of gram force (gf) in the present embodiment, to the vibrating body 104.

Two ball rails 115a and 115b that clamp three rolling balls 114 are provided in the side surface portion along the longitudinal direction of the contact body holder 113. When the ball rails 115a and 115b are fixed to the base stage 118 in this state, the contact body 101 and the contact body holder 113 can move in the X-direction with respect to other components. The output is transmitted to the outside by an output transmission portion of a desired shape being attached to the contact body holder 113.

### Contact Body

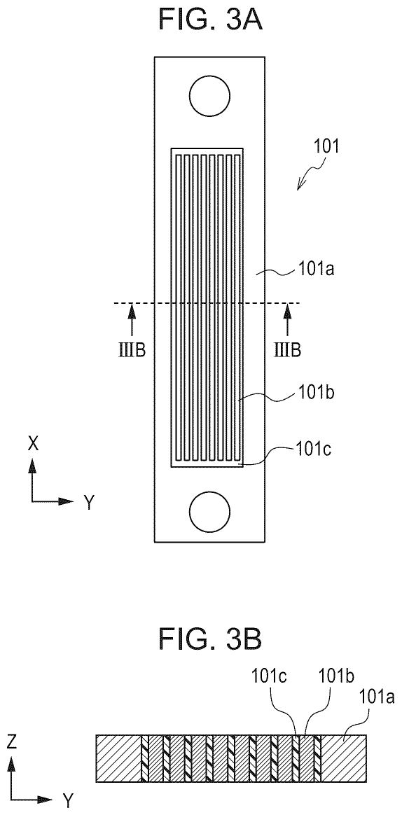

FIGS. 3A and 3B are diagrams for describing the contact body 101 according to the present embodiment. FIG. 3B is a cross-sectional view of the contact body 101 illustrated in FIG. 3A taken along line IIIB-IIIB. The contact body 101 includes a frame portion 101a, a plurality of thin plate portions 101b, and a resin portion 101c. The plurality of thin plate portions 101b is an example of the plurality of thin plate portions included in the hard material portion according to the present disclosure.

Thin plates used as the thin plate portions 101b may be made of martensitic stainless steel, such as, for example, SUS420J2. A hardening treatment is applicable such that the Vickers hardness of the thin plate portions 101b is 550 HV0.2 or higher, preferably 600 HV0.2 or higher to improve the abrasion resistance of the friction sliding surface.

It should be noted that, a micro-Vickers hardness tester with a test force of 200 grams (0.2 kg) can be used with respect to a polished metal surface to measure Vickers hardness. A nitriding treatment may be performed on the thin plate to further improve abrasion resistance, and a nitride layer with a hardness of 900 HV0.2 or higher may be formed. When a nitriding treatment is performed, the material of the thin plate portions 101b may be austenitic stainless steel, such as SUS304.

The thickness of the thin plate portions 101b can be smaller than the width of the surfaces of the two projecting portions 102a of the vibrating body 104 in contact with the contact body to improve the friction force on the contact surface. In the present embodiment, for example, the thin plates with a thickness of 0.1 mm or more and 0.3 mm or less can be used. The plurality of thin plate portions 101b has a rectangular shape and are arranged such that two largest surfaces of the six surfaces of the thin plate portions 101b face each other. In other words, the thin plate portions 101b are laminated together such that the thickness direction (plate thickness direction) is aligned with the Y-direction.

A resin portion 101c is provided in a gap between the plurality of thin plate portions 101b, and the plurality of thin plate portions 101b is bonded (coupled) to the frame portion 101a via the resin portion.

The resin portion 101c can be an epoxy resin in which SiC abrasive gains (GC), which are hard particles, are dispersed to increase the friction force of the contact surface. The thickness of the resin portion 101c and the width of the frame portion 101a can be set such that the ratio (area) of the resin to the entire surface through which the projecting portion 102a is in contact with the contact body is 10% or more and 20% or less.

It should be noted that some portions (unfilled portions) of the gaps between the plurality of thin plate portions 101b may be unfilled with resin portions. Due to presence of unfilled portions, it is expected that the wear powder generated during the operation of the vibration actuator enters unfilled portions to prevent the wear powder from scattering.

### Method of Manufacturing Contact Body

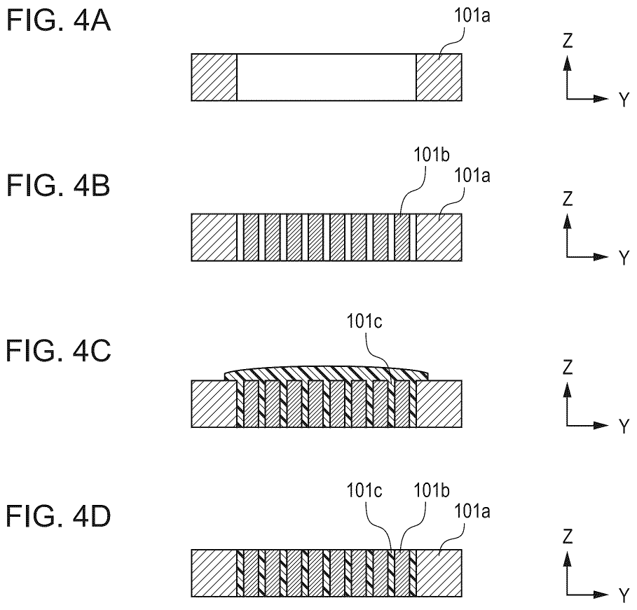

FIGS. 4A to 4D are cross-sectional views for describing the method of manufacturing the contact body 101 in FIG. 3. First, the frame portion 101a illustrated in FIG. 4A is prepared. The frame portion 101a has through-holes in which the plurality of thin plate portions is disposed. The surface that serves as the contact surface of the frame portion 101a is polished in advance to reduce the flatness.

After that, as illustrated in FIG. 4B, the quenched thin plates are disposed in the through holes of the frame portion 101a. At this time, the plurality of thin plate portions is arranged in the thickness direction. Next, a two-pack curing liquid adhesive is prepared. A fluorescent dye for facilitating observation can be added to the adhesive. For example, a liquid epoxy resin can be used as the main component of the main ingredient and an amine compound can be used as the main component of the curing agent. In addition, Silicon carbide (SiC) abrasive grains (GC), which are hard particles, can be dispersed in the resin to further enhance the effect of the holding force of the vibration actuator.

As illustrated in FIG. 4C, the resin is applied to the side surface of the arranged thin plates. After that, the epoxy resin is cured and left at approximately 80° C. such that the plurality of thin plate portions 101b is integrated with the resin portion 101c.

In this series of steps, since the amount of the resin applied is larger than the amount of actual impregnation (penetration), the cured resin remains on the surface to which the resin has been applied and the opposite surface. Grinding is performed after the resin is cured to remove the resin and adjust the flatness of the contact surface and the back surface and the thickness of the contact body 101 to certain values. In addition, a polishing is applied to adjust the surface roughness of the surface of the contact body 101, and the contact body 101 as a finished product is obtained. It should be noted that polishing can be performed by using a copper surface plate and diamond loose abrasive grains (3 micrometer (μm)).

In the structure of the present embodiment, even if there is a variation in the amount of grinding, a fluctuation in the ratio of the resin to the contact surface of the contact body is reduced. As a result, a variation in performance caused by a variation in the amount of polishing or the like can be reduced, and the contact body with a high holding force can be provided.

It should be noted that the material of the thin plate portions constituting the hard material portion is a metal in the exemplary embodiment, but the material of the plate may also be a high-hardness ceramic, such as alumina, to improve abrasion resistance or the like.

### Second Embodiment

In a second embodiment, a first variation example of the contact body 101 will be described. It should be noted that, since other components, such as the vibrating body 104, are the same as those in the first embodiment, detailed description thereof is omitted. When the vibrating body 104 moves from one end portion of the contact body (slider) to the other end portion in the first embodiment, a portion always in contact with the resin portion and a portion always in contact with the metal portion (hard material portion) are present on the projecting portion of the vibrating body 104. Since the wear of the portion always in contact with the resin portion is small and the wear of the portion always in contact with the metal portion is large, a groove parallel to the driving direction may be formed in the projecting portion depending on the driving condition. In addition, since the resin portion of the contact body 101 is more likely to wear than the metal portion, the projecting portion of the vibrating body 104 meshes with the contact body 101, and the driving performance may become unstable.

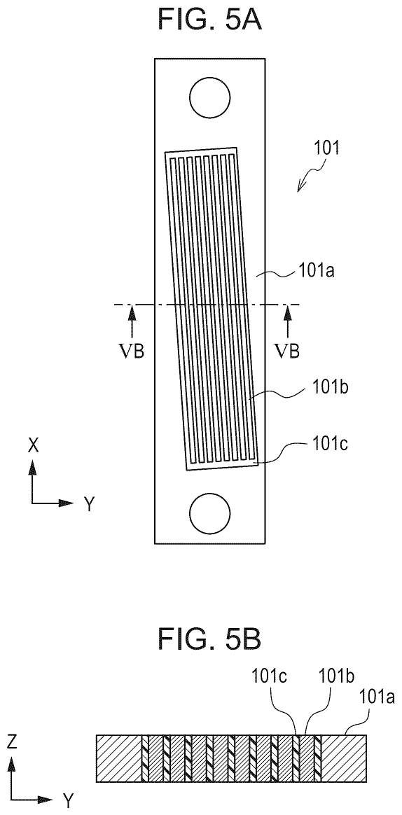

FIGS. 5A and 5B are diagrams for describing the contact body 101 according to the second embodiment, and FIG. 5B is a cross-sectional view taken along line VB-VB in FIG. 5A. The second embodiment differs from the first embodiment in that the longitudinal direction of the thin plate portions 101b is not parallel to the X-direction, which is the driving direction of the contact body 101, that is, the longitudinal direction differs from the X-direction. When the vibrating body 104 moves from one end of the contact body (slider) to the other end in this structure, the portion always in contact with the resin portion or the portion always in contact with the metal portion (hard material portion) is not present on the projecting portion of the vibrating body 104. Accordingly, since a groove parallel to the driving direction can be prevented from being formed in the projecting portion, the driving performance becomes stable.

It should be noted that the material of the thin plate portions is a metal as an example in the present embodiment, but the material may also be a high-hardness ceramic, such as alumina, to improve abrasion resistance and the like.

### Third Embodiment

In a third embodiment, another variation example of the contact body 101 will be described. It should be noted that, since other components, such as the vibrating body 104, are the same as those in the first embodiment, detailed description thereof is omitted.

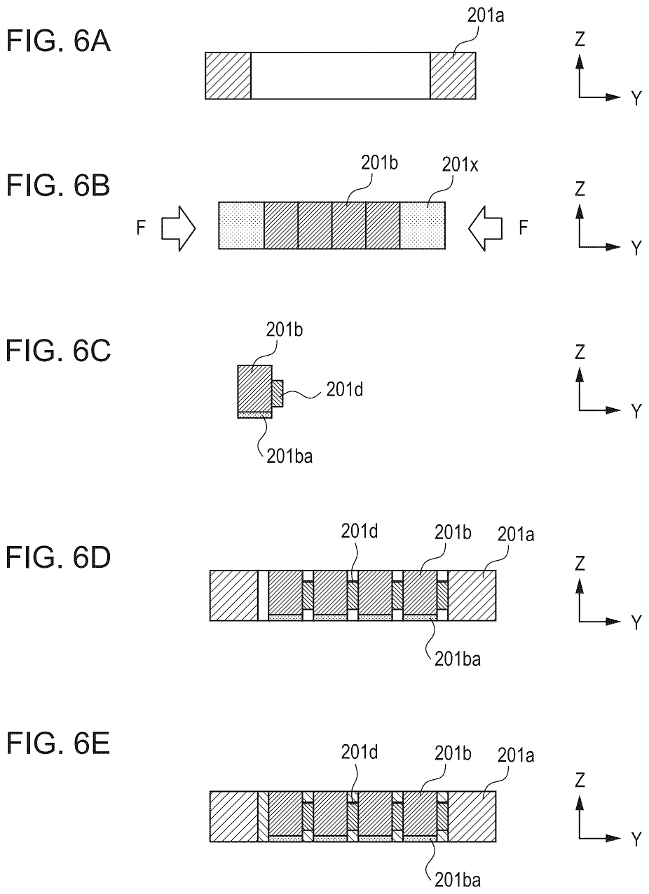

FIGS. 6A to 6E are cross-sectional views for describing the contact body 101 according to the third embodiment and a manufacturing method thereof. FIG. 6E illustrates the completed contact body 101 and includes a frame portion 201a, a plurality of thin plate portions 201b, a resin portion 201c, and a spacer 201d. The spacer is not particularly limited as long as it is a member with a certain thickness, but it can be a single-sided adhesive tape or a double-sided adhesive tape for ease of fixation.

The thin plate portions 201b can be made of austenitic stainless steel, such as SUS304. A nitriding treatment can be performed on the thin plate portions 201 to improve the abrasion resistance of the friction sliding surface, and a nitride layer 201ba with a Vickers hardness of 900 HV0.2 or larger can be provided. It should be noted that the Vickers hardness can be measured by using a micro-Vickers hardness tester having a test force of 200 g (0.2 kg) with respect to a polished metal surface.

The thickness of the thin plate portions 201b can be smaller than the width of the surfaces of the two projecting portions 102a of the vibrating body 104 in contact with the contact body. In the present embodiment, for example, the thin plates with a thickness of 0.1 mm or more and 0.3 mm or less can be used. The plurality of thin plate portions 201b has a rectangular shape and are arranged such that two largest surfaces of the six surfaces of the thin plate portions 201b face each other. In other words, the thin plate portions 201b are arranged such that the thickness direction (plate thickness direction) of the thin plate portions 201b is aligned with the Y-direction.

The resin portion 201c is provided in the gap between the plurality of thin plate portions 201b, and the plurality of thin plate portions 201b is bonded (coupled) to the frame portion 201a via the resin portion 201c. In addition, the spacer 201d that is smaller than the width of the thin plate portions in the thickness direction is provided in the gap between the thin plate portions 201b, and the width of the gap between the thin plate portions is fixed by the thickness of this spacer. It should be noted that the spacer 201d can be unexposed to the contact surface to improve the friction force of the contact surface, and the spacer 201d can be pre-cut into a shape smaller than the thin plate portions.

In the resin portion 201c, SiC abrasive particles (GC), which are hard particles, can be dispersed in an epoxy resin. The thickness of the resin portion 201c sets the thickness of the spacer 201d such that the ratio (area ratio) of the resin to the entire surface of the two projecting portions 102a of the vibrating body 104 in contact with the contact body is 10% or more and 20% or less.

### Method of Manufacturing Contact Body

The method of manufacturing a contact body 201 will be described with reference to FIGS. 6A to 6E. First, the frame portion 201a illustrated in FIG. 6A is prepared. The surface that serves as the contact surface of the frame portion 201a is polished in advance to increase the flatness. After that, as illustrated in FIG. 6B, the plurality of thin plate portions 201b is stacked together and brought into contact and pressed by a jig 201x from both sides, and accordingly, and a nitriding treatment is performed with the plurality of thin plate portions 201 in close contact with each other.

Since a nitride layer containing a metal nitride formed by a nitriding treatment is brittle, when a nitride layer is formed throughout the thin plate portions 201b, cracking is likely to occur. Accordingly, a method that masks the surface orthogonal to the thickness direction by stacking the thin plate portions 201b together in the thickness direction and bringing them into contact. A nitride layer 201ba can be formed only in a region near the end face by nitriding only the end face (the surface that constitutes the thickness direction) of the thin plate portions 201b with the surface orthogonal to the thickness direction, that is, the surface facing the gap between the thin plate portions masked. As a result, since the portion away from the end faces of the thin plate portions 201b has a high toughness metal, cracking of the thin plate portions 201b can be reduced.

In the method described above, cracking is less likely to occur even when the depth of the nitride layer is increased to approximately 40 μm, and the nitride layer can be left on the surface even when the amount of polishing increases in a subsequent polishing step. In other words, the nitride layer 201ba can be located on the contact surface of the contact body in contact with the vibrating body 104.

Next, a spacer 201d is attached to surfaces of the thin plate portions 201b that form the gap between the thin plate portions 201b. When a double-sided adhesive tape is used as the spacer, the thin plate portions 201b are positioned by a jig (not illustrated) and integrated. After that, as illustrated in FIG. 6D, the plurality of thin plate portions 201b having the spacers 201d in the gaps is inserted into through-holes of the frame portion 201a. Next, an epoxy resin is applied in the Z-direction, and polishing is performed after the resin is cured to obtain the contact body 201 illustrated in FIG. 6E.

It should be noted that, an example in which the material of the thin plate portions is a metal has been described in the present embodiment, but a high-hardness ceramic, such as alumina, may also be used as the material of the thin plate portions to improve abrasion resistance.

### Fourth Embodiment

In a fourth embodiment, a variation example of the contact body 101 will be described. It should be noted that, since other components, such as the vibrating body 104, are the same as those in the first embodiment, detailed description thereof is omitted.

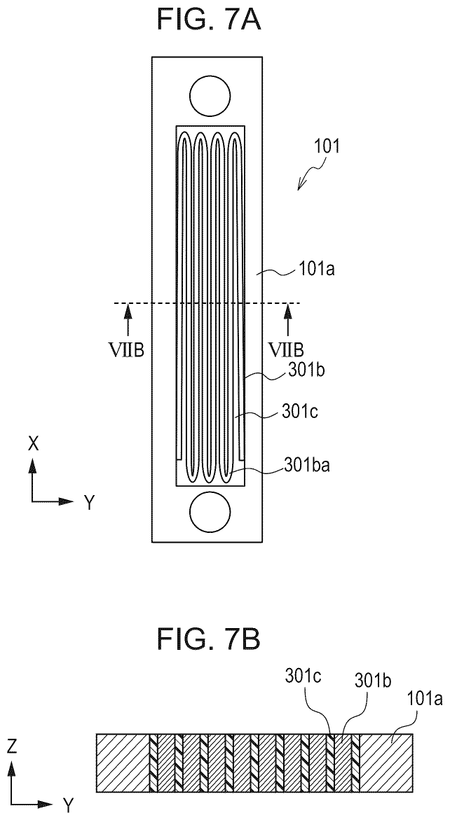

FIGS. 7A and 7B are diagrams for describing the contact body 101 according to the present embodiment, and FIG. 7B is a cross-sectional view taken along line VIIB-VIIB in FIG. 7A. The difference from the first embodiment is that a structure in which a thin plate portions 301b are connected to each other is included. For example, the thin plate portions 301b may be connected to each other to form a single member. Here, each of the thin plate portions 301b includes a planar portion and a bent portion 301ba, and the flat portion is connected by the bent portion. By using the thin plate portions connected in advance instead of the spacer, a certain amount of the resin can be present in the gap between the thin plate portions.

When the thin plate portions 301b connected to each other have a spring property, the effect of equalizing the gap between the flat portions in accordance with the width of the frame portion 101a when the thin plate portions 301b are inserted into the through-holes provided in the frame portion 101a is expected. Since the gap is equalized, the contact body with a structure having a desired resin content can be manufactured without using the spacer.

It should be noted that an example in which the material of the thin plate portions is a metal has been described in the present embodiment, a high-hardness ceramic, such as alumina, may be used as the material of the thin plate portions to improve abrasion resistance and the like.

### Fifth Embodiment

Next, an imaging device and an industrial robot will be described as examples of an optical device and an electronic device including the vibration actuator described above.

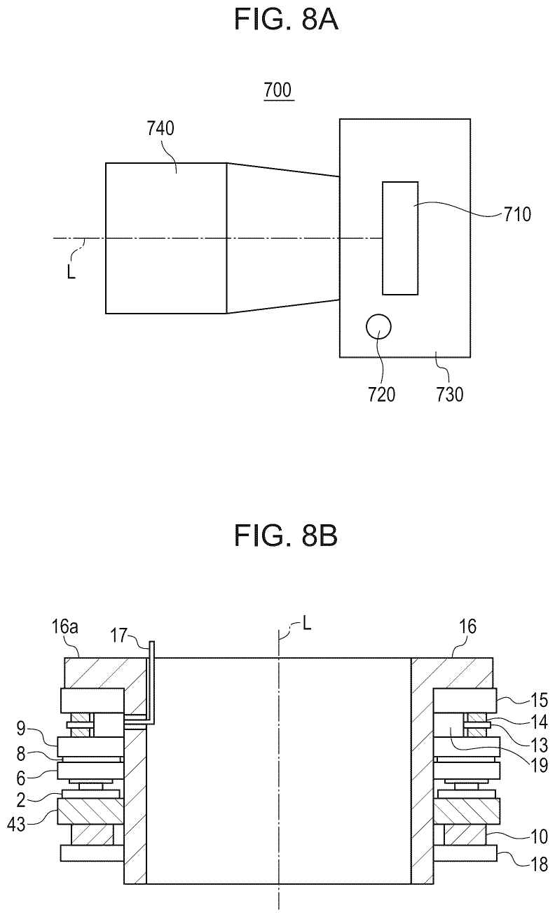

FIG. 8A is a top view illustrating the schematic structure of an imaging device 700 (optical device). The imaging device 700 includes a camera body 730 in which an imaging element 710 and a power supply button 720 are installed. The imaging device 700 further includes a lens barrel 740 including a lens group (not illustrated) that includes optical elements and a vibration actuator. The lens group is driven by the vibration actuator. The lens barrel 740 can be exchangeable as an interchangeable lens, and the lens barrel 740 suitable for a subject to be imaged can be attached to the camera body 730. This vibration actuator can be one of the vibration actuators described in the first to fourth embodiments.

The type of a lens suitable to be driven by a vibration actuator is an autofocus lens, but a zoom lens can also be driven by the same structure. In addition, a vibration actuator can also be used to drive an imaging element or to drive a lens or an imaging element during image stabilization.

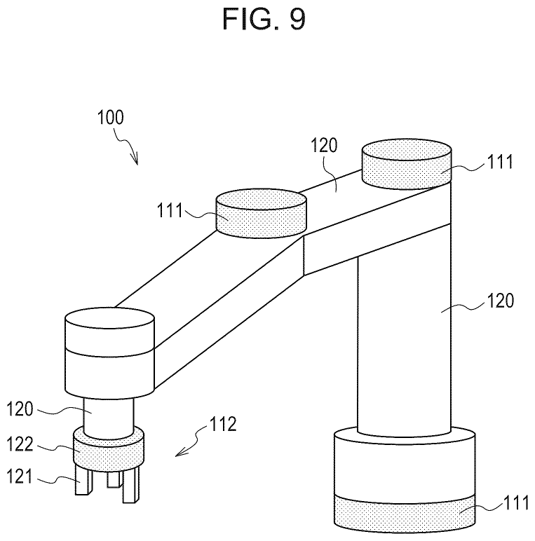

FIG. 9 is a perspective view illustrating the schematic structure of a robot 100 (electronic device) including a vibration actuator and, here, illustrates a horizontal multi-joint robot, which is a type of an industrial robot. The robot 100 includes an arm joint portion 111 and a hand portion 112. The arm joint portion 111 connects two arms 120 to each other such that the angle formed by the two arms can be changed. The hand portion 112 includes the arm 120, a holding portion 121 attached to one end of the arm 120, and a hand joint portion 122 that connects the arm 120 and the holding portion 121 to each other. The vibration actuator is built into the arm joint portion 111 and the holding portion 121 to perform angle adjustment and rotational operation of the arm 120 and the hand joint portion. It should be noted that a vibration actuator with TN characteristics (hanging characteristics indicating the relationship between load torque and rotation speed) can be used for bending of the arm joint portion 111, which is an example of a member, and holding operation of the hand portion 112, which is an example of a member.

The present disclosure has been described in detail above based on embodiments, but the present disclosure is not limited to these specific embodiments, and various forms within the scope of the concept of the present disclosure are also included in the present disclosure. For example, an XY stage can be used as a device capable of driving a planar contact body in any direction within a plane thereof.

According to the present disclosure, a vibration actuator with a small variation in performance and a high holding force can be provided. In addition, according to the present disclosure, an optical device or an electronic device including a vibration actuator with a small variation in performance and a high holding force can be provided.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-050590, filed Mar. 26, 2024, which is hereby incorporated by reference herein in its entirety.

What is claimed is:

1. A vibration actuator comprising:
a vibrating body including an electrical energy-mechanical energy conversion element and an elastic body; and
a contact body in contact with a surface of the elastic body via a contact surface, vibration of the vibrating body causing relative movement of the vibrating body with respect to the contact body,
wherein the contact body includes a hard material portion and a resin portion,
the hard material portion and the resin portion are exposed to the contact surface, and
the hard material portion includes a plurality of thin plate portions, and the resin portion is present at least in a gap between the thin plate portions.

2. The vibration actuator according to claim 1,
wherein the hard material portion includes at least one of a metal and a ceramic.

3. The vibration actuator according to claim 1,
wherein the plurality of thin plate portions is stacked together in a direction different from a direction of the relative movement.

4. The vibration actuator according to claim 1,
wherein the plurality of thin plate portions is stacked together in a thickness direction of the plurality of thin plate portions.

5. The vibration actuator according to claim 1,
wherein the hard material portion includes a structure in which end portions of the plurality of thin plate portions are connected to each other.

6. The vibration actuator according to claim 1,
wherein the elastic body includes a projecting portion in contact with the contact body, and
a thickness of the plurality of thin plate portions is smaller than a width of the projecting portion in a direction orthogonal to a direction of the relative movement.

7. The vibration actuator according to claim 1,
wherein a spacer containing a double-sided adhesive tape or a single-sided adhesive tape is present in a gap between the plurality of thin plate portions.

8. The vibration actuator according to claim 1,
wherein the plurality of thin plate portions contains a metal nitride on a surface exposed to the contact surface and contains a metal on a surface facing the gap between the plurality of thin plate portions.

9. An optical device comprising:
a vibration actuator including a vibrating body including an electrical energy-mechanical energy conversion element and an elastic body, and a contact body in contact with a surface of the elastic body via a contact surface, vibration of the vibrating body causing relative movement of the vibrating body with respect to the contact body;
an optical element; and
an imaging element, at least one of the optical element and the imaging element being driven by the vibration actuator,
wherein the contact body includes a hard material portion and a resin portion,
the hard material portion and the resin portion are exposed to the contact surface, and
the hard material portion includes a plurality of thin plate portions, and the resin portion is present at least in a gap between the thin plate portions.

10. An electronic device comprising:
a vibration actuator including a vibrating body including an electrical energy-mechanical energy conversion element and an elastic body, and a contact body in contact with a surface of the elastic body via a contact surface, vibration of the vibrating body causing relative movement of the vibrating body with respect to the contact body; and
a member driven by the vibration actuator,
wherein the contact body includes a hard material portion and a resin portion,
the hard material portion and the resin portion are exposed to the contact surface, and
the hard material portion includes a plurality of thin plate portions, and the resin portion is present at least in a gap between the thin plate portions.

11. A member comprising:
a hard material portion; and
a resin portion,
wherein the hard material portion and the resin portion are exposed to a surface of the member,
the hard material portion includes a plurality of thin plate portions, and the resin portion is present at least in a gap between the thin plate portions, and
the plurality of thin plate portions is stacked in a thickness direction of the plurality of thin plate portions.

12. A method of manufacturing a vibration actuator including an elastic body and a contact body in contact with the elastic body, the method comprising:
an impregnating step of impregnating a gap between a plurality of thin plates with a resin with the plurality of thin plates arranged in a thickness direction;
a polishing step of polishing a surface of the member impregnated with the resin to obtain a contact body having a surface to which the resin and the plurality of thin plates are exposed; and
an assembling step of performing assembling such that the contact body and the elastic body are in contact with each other.

13. The method of manufacturing a vibration actuator according to claim 12,
wherein a nitriding step of nitriding the plurality of thin plates with the plurality of thin plates stacked together in the thickness direction is performed prior to the impregnating step.
